(19) United States
(12) Patent Application Publication
(10) Pub. No.: US 2004/0175469 A1
(43) Pub. Date: Sep. 9, 2004

(54) Tortilla wrap food product and method for making same

(76) Inventor: Danny Janecka, (US)

Correspondence Address: JACKSON WALKER L.L.P., Suite 2100, 112 E. Pecan Street, San Antonio, TX, 78205, US

(21) Appl. No.: 10/805,927

(22) Filed: Mar. 22, 2004

Related U.S. Application Data
(63) Continuation-in-part of application No. 10/407,014, filed on Apr. 4, 2003.
(60) Provisional application No. 60/456,076, filed on Mar. 20, 2003.
(60) Provisional application No. 60/370,374, filed on Apr. 5, 2002.

(51) Int. Cl. A23G 1/00

(52) U.S. Cl. 426/274

(57) ABSTRACT

A food product and a method for making the food product. The food product comprises a tortilla shell, typically having perforations therein, in which a cylindrical food product, such as a sausage link or frankfurter is tightly wrapped. The method includes heating, as by deep frying or on a roller grill, the novel food product.

This application claims priority from U.S. application No. 60/456,076 filed Mar. 20, 2003 and incorporates by reference the '076 application. This application also claims priority from (and is a continuation in part of) U.S. patent application Ser. No. 10/407,014, filed Apr. 3, 2003 (which claims priority from U.S. application No. 60/370,374, filed Apr. 5, 2002).

### FIELD OF THE INVENTION

### BACKGROUND OF THE INVENTION

Mexican food items, on the whole, are enjoying great popularity. Tortillas are sometimes used as a cover for wrapping a food item such as a sausage link wrap or an egg-based product. Often, a sausage link or other food item may be wrapped in a tortilla and served in this manner. Applicant provides a novel tortilla wrap food product with a number of novel variations thereto.

First, Applicant provides for a cylindrical food item, such as a sausage link or a frankfurter, wrapped tightly in a tortilla, heated and served hot. Applicant provides a number of novel variations in this food wrap including a variation which utilizes a tortilla shell that has been perforated prior to combining with a food product and heating the combined food. Applicant has found that providing perforations to the tortilla shell prior to heating avoids swelling and delamination of the tortilla shell when it is heated.

In another preferred embodiment of the tortilla food wrap product, Applicant provides for the maintenance of a soft and pliable tortilla shell by coating with oil at least one side, typically the outer side of the tortilla, prior to rolling the sausage link therein. Applicant has found that this allows the tortilla to maintain its softness and pliability especially during heating, as for example, heating on a roller grill.

In an alternate preferred embodiment of the perforated tortilla, Applicant provides for a special blend or recipe that allows the tortilla shell to stay moist for a longer period of time and maintain its freshness.

Applicant also provides a method for perforating the tortilla, including a novel quill cutter for perforating the tortilla shell prior to wrapping and heating of the food product.

### OBJECTS OF THE INVENTION

It is an object of the present invention to provide for a novel tortilla food wrap product. It is another object of the present invention to provide for a novel food wrap product in which a cylindrical food item, such as a sausage is rolled in a tortilla shell and served heated.

It is yet another object of the present invention to provide for a tortilla wrapped food product in which the tortilla is perforated.

It is yet another object of the present invention to provide for a tortilla wrapped food product in which the tortilla shell is perforated before wrapping the food product and subsequent heating of the tortilla wrapped food product.

It is yet another object of the present invention to provide for a tortilla wrapped food product, including a novel method of making the same, wherein the tortilla shell is, prior to combining with the food core, coated with a vegetable oil to maintain softness during subsequent heating.

It is another object of the present invention to provide a method of preparing a novel tortilla wrapped food product by perforating the tortilla shell prior to combining with the food core to prevent subsequent swelling, cracking or delamination of the tortilla during the heating process.

It is yet another object of the present invention to provide for a tortilla wrapped food product, in which the tortilla shell is perforated before wrapping the food product and then deep drying to tortilla wrap food product for the purpose of adding color, flavor, and a fluffy texture to the tortilla.

### SUMMARY OF THE INVENTION

Applicants provides a circular tortilla shell with a cylindrical food core such as a sausage rolled therein.

Applicant further provides for a novel food product in providing a tortilla shell, typically circular, to which a layer of vegetable oil has been applied to the surface thereof, for rolling a cylindrical food product such as a sausage therein.

Applicant provides a novel tortilla food product and a method of making the same in providing a perforated tortilla in which a core food product, typically cylindrical, is placed, wrapped therein and heated.

Applicant provides for these objects and more in providing a novel quill cutter designed for perforating a tortilla.

Applicant provides for these objects and more in providing a novel method of making a tortilla by providing a coating of oil, typically vegetable oil, to the surface of the tortilla prior to combining it with a core food product.

### BRIEF DESCRIPTION OF THE DRAWINGS

FIGS. 1A and 1B illustrate, in perspective view, cross section and non-cross sectional views of Applicant's novel tortilla wrap food product.

FIGS. 2A and 2B illustrate, in perspective view, (cut away and non-cut away) the results of heating (as by deep frying), a tortilla food wrap product without providing perforations to the tortilla shell thereof, these Figures provided, in part, for comparison to FIGS. 1A and 1B.

FIGS. 3A and 3B illustrate, in elevational views, a tortilla shell (round perforation) and a cylindrical food core for use in preparation of Applicant's novel food product.

FIG. 3C illustrates a tortilla shell having elongated or slot shaped perforations.

FIG. 4 illustrates a flow chart setting forth preferred methods of preparing Applicant's novel food product illustrated in FIGS. 1A and 1B.

FIG. 5 illustrates, in perspective view, partially cut away, a deep fryer for use and deep frying Applicant's novel food product.

FIG. 6 illustrates a roller grill for use in heating Applicant's novel tortilla wrap food product, in perspective view.

FIG. 7 illustrates a novel quill cutter and a novel method of perforating the tortilla shell of Applicant's novel food wrap item.

FIGS. 8A and 8B illustrate, in perspective view, a method of hand rolling Applicant's tortilla food wrap product.

FIG. 8C illustrates, in perspective view, the step of applying some water to a surface of the tortilla shell, as, for example, by misting.

FIGS. 9 and 10 illustrate, in perspective view, an open condition (FIG. 9) and a closed condition (FIG. 10) of a novel case for molding, storing, transportation of a multiplicity of Applicant's novel tortilla wrap food products.

### DETAILED DESCRIPTION OF THE PREFERRED EMBODIMENTS

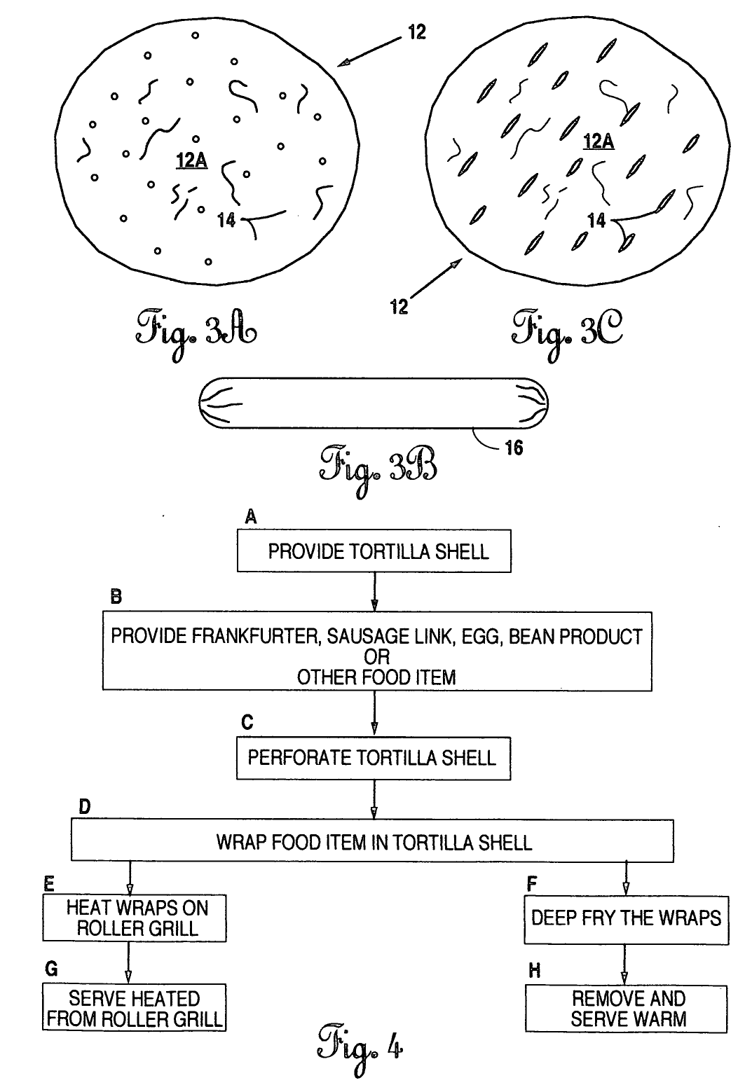

FIGS. 1A and 1B illustrate a novel tortilla food wrap product (10) including a tortilla shell (12) having an inner face (12A) (See FIG. 3A) and an outer face (12B) and perforations (14) there through (that is, through the tortilla shell) which shell is wrapped around a cylindrical food core (16) such as a sausage link or frankfurter.

FIGS. 1A and 1B illustrate such a novel tortilla food wrap product (10) having perforations (14) in the tortilla shell (12). More specifically, FIG. 1A illustrates the novel tortilla wrap food product (10) after it has been heated in the manner set forth below, which illustration shows the food product in two sections, the result of a cut transversely to a longitudinal axis for an illustration of how the tortilla shell maintains its integrity and tight wrap during the heating process. FIG. 1B illustrates the preheating configuration of the tortilla wrap food product (10) after the cylindrical food core (16) has been rolled into the tortilla shell.

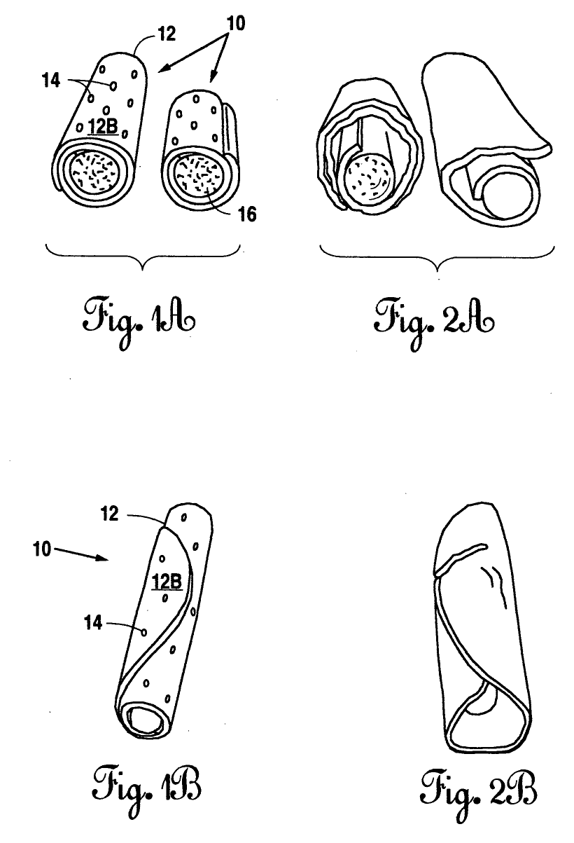

FIGS. 2A and 2B are provided to illustrate the results of heating, as by deep frying, the tortilla wrap food product illustrated in FIGS. 1A and 1B without, however, providing perforations to the tortilla shell. Note in particular the swelling that occurs between the inner and outer layer of the tortilla shell and, further, the separation that may occur from the food core. It may be appreciated that asthetics, texture, integrity and taste are all improved with the perforations of Applicant's novel tortilla wrap product and method of making the same, when comparing FIGS. 1A and 1B to FIGS. 2A and 2B. Applicant has confirmed improved texture and taste and other advantages with use of the perforated tortilla shell.

FIGS. 3A and 3B illustrate a typical starting point for the preparation of Applicant's novel tortilla wrap food product. More specifically, FIG. 3A illustrates a typical prepared tortilla shell that has already been heated, though it is not typically nor necessarily hot during the wrapping process. While any of the many tortilla shells commercially available may be used for perforation, Applicant's tortilla shell, in a preferred embodiment, would have, especially for the product that is intended to be heated on a roller grill (see FIG. 6), a recipe including more oil, typically from ½ to 1 percentage vegetable oil. The addition of oil to the method of heating, as on a roller grill, of Applicant's product may be used instead of misting to help hold the product together before, during, and after heating.

Perforations (14) are illustrated, here in a random pattern and extending completely through the tortilla shell. FIG. 3B illustrates a typical cylindrical core food product such as a sausage link, hot dog, egg product or bean product. The cylindrical core product would typically have a longitudinal axis that would be equal to approximately the diameter of the typically circular tortilla illustrated in FIG. 3A.

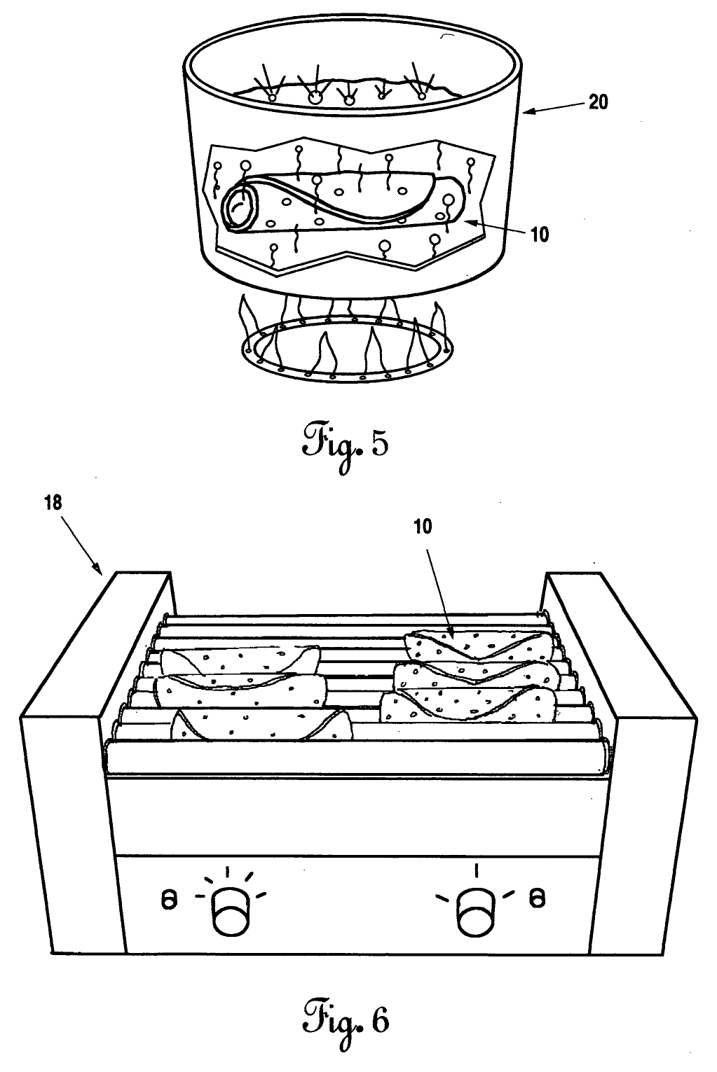

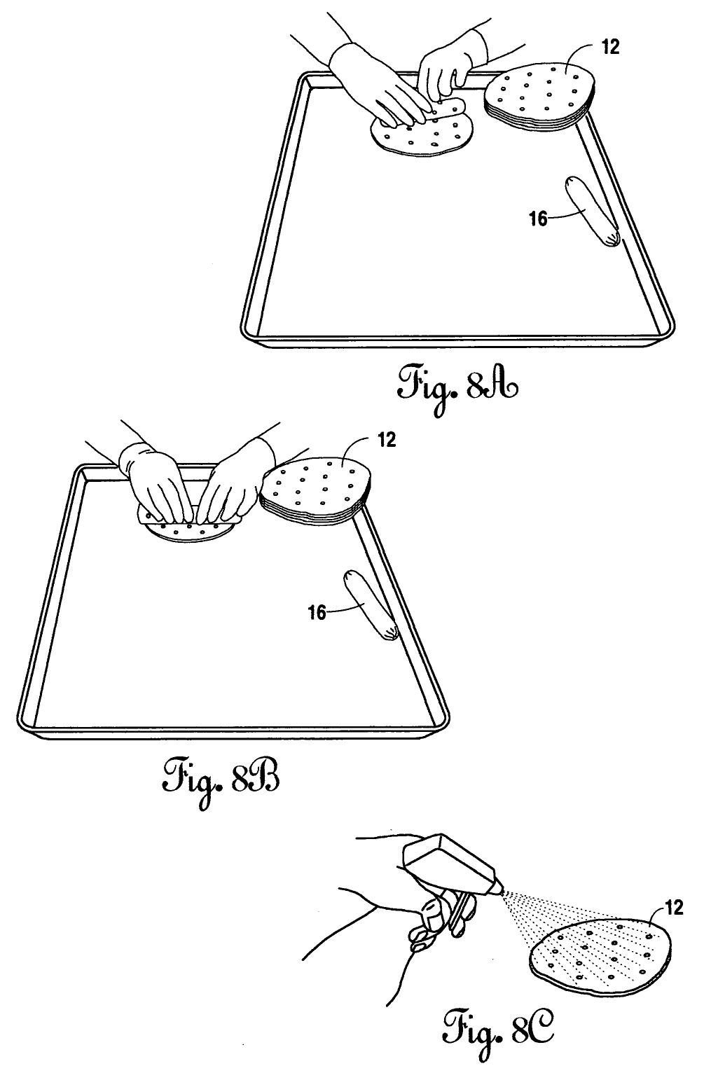

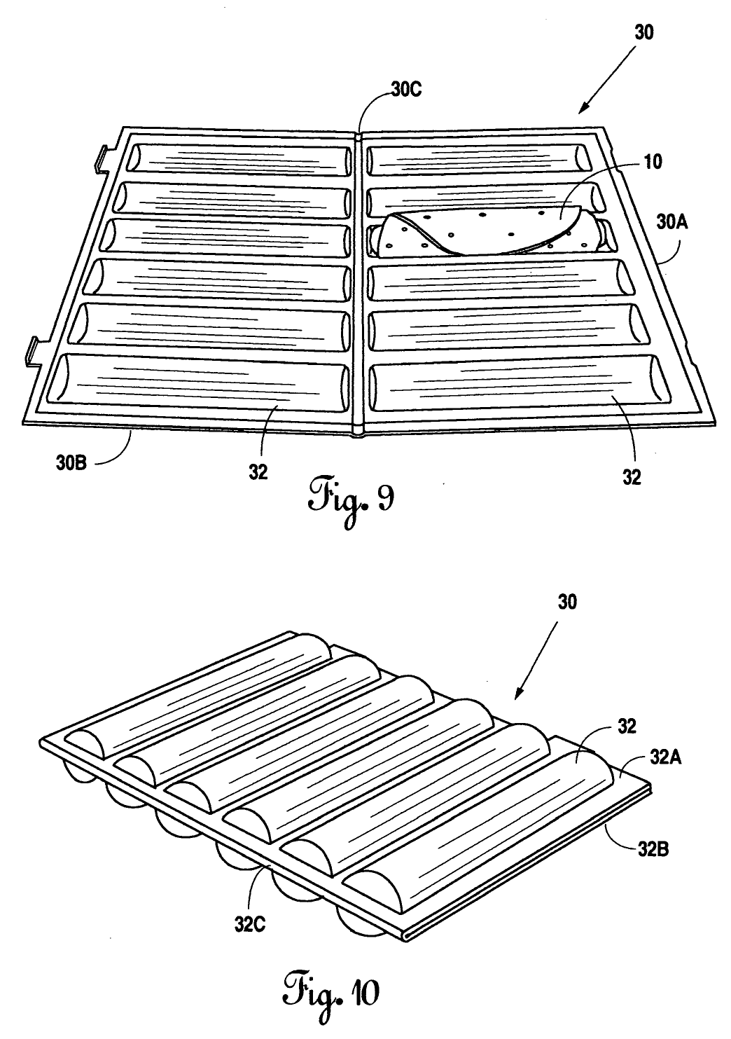

FIG. 4 illustrates a preferred method of making the novel food product illustrated in FIGS. 1A and 1B. Step A includes a step of providing cooked ready to heat and eat tortilla shells, such as flour tortillas. Step B includes a step of providing a typically precooked core food product such as a bean product, egg product, sausage or hot dog link. Tortilla shells and precooked sausage or frankfurter links are readily available from known sources. Step C includes a step of perforation of the tortilla shells which may be perforated by any manner, such as manually by a pick or a quill or by automated procedures (see FIG. 7 below). The perforations may be random or have a regular pattern. The perforations may be cylindrical, slotted, elongated or any other shape (compare FIGS. 3A and 3C). Optionally, flavoring may be applied to the tortilla shell, typically before wrapping. Step D includes a step of wrapping the sausage link snuggly in a tortilla shell and may, optionally include the step of misting with water (see FIG. 8C) at least a portion of the inner surface of the tortilla prior to wrapping so as to help the inner surface stick to the outer surface of the tortilla (where it overlaps) when tightly rolled around the food product. Misting may especially be useful with those food items to be heated on a roller grill.

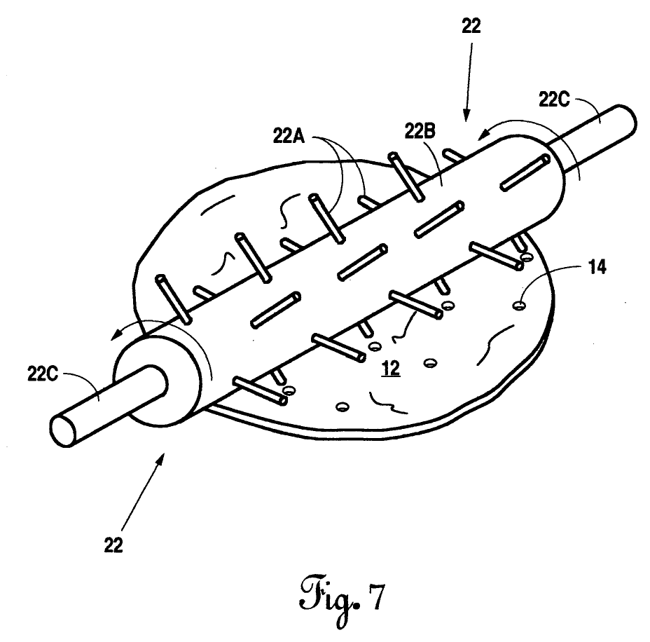

Following wrapping of the sausage in the tortilla, the food product may either be heated as by placement on a roller grill (Step E) (see FIG. 6) or as by deep frying (Step F) (see FIG. 5). Optionally, prior to heating steps (E) or (F) and after wrapping, the food product may be frozen and packed for later thawing, heating, and use. Following heating on a roller grill, oven, microwave or deep frying (or any other suitable manner), the food product is removed and cooled (Step G) and then served, typically while still warm (Step H). Certain details of the method set forth in FIG. 4 will be discussed below.

FIGS. 5 and 6 illustrate two methods of heating Applicant's novel tortilla wrap product (10). FIG. 6 illustrates a roller grill (18) having a multiplicity of heated rollers. Such roller grills are known in the art. One such roller grill that may be used with Applicant's novel method and food product includes one manufactured by STAR of Smithville, Tenn., as Model No. 258. The STAR machine may be set on a low setting and will satisfactorily cook, in 10 to 14 minutes, a 2 ounce skinless sausage, 6 inches long and about ⅞″ in diameter, wrapped in a 6-inch diameter flour tortilla about 1/16″ thick. It is typically preferred that the roller grill heat the interior of the sausage link to at least about 145° F.

FIG. 5 illustrates a deep fryer machine (20) such as the deep fryer machine for making french-fries or any other deep fried food product. A deep fryer machine (20) is provided with sufficient cooking oil, such as peanut, canola or vegetable oil, to completely immerse the food product. The oil may be heated to about 350° (typically 300°-500°) in which case submersion of the 2-ounce skinless frank in the 6-inch tortilla will be cooked to a light golden brown and removed after about four minutes.

FIG. 7 illustrates one manner of performing the step of perforating the tortilla shell (12) with perforations (14). The step illustrated in FIG. 7 involves the use of a novel quill cutter (22). Quill cutter (22) is a device that includes a multiplicity of elongated cylindrical solid or hollow quills (22A) extending from a cylindrical frame (22B), the frame typically mounted rotatably to a pair of handles (22C), the handles coincident with a longitudinal axis of the cylindrical frame. The device may be rolled across a flat laying tortilla shell (12). The removed ends of the quill will create perforations (14) through the body of the tortilla shell.

FIGS. 8A and 8B illustrate a manner of manually rolling a tortilla wrap food product (10) by rolling an elongated, cylindrical food core product (16) in a flat tortilla shell (12) which has perforations (14) there through. The steps include placing the food product centrally across one edge of the tortilla shell and rolling it into the shell such that the shell fits snuggly about the food product. FIG. 8C illustrates a manner in which a bottle containing water may be used to apply a spray mist of water to the inside surface of the tortilla shell prior to wrapping. This helps maintain the integrity of the wrap.

FIGS. 9 and 10 illustrate a food product case (30), such as a case made out of durable plastic or the like, for the molding, storage, and transportation of a multiplicity of tortilla wrap food products (10) therein. As can be seen in the figures, the case is of clamshell construction with mirrored shell halves (30A and 30B) joined along a hinge (30C). The halves include matching cutouts (32) that, when the two halves are folded over in a carrying position as illustrated in FIG. 10, are dimensioned to snuggly receive the cylindrical food wrap therein such that the tortilla does not start to unfold or unwrap from the cylindrical shape. This case may be used for carrying, storage and freezing the food products.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. A method of making and handling a tortilla wrapped food product, the method comprising the steps of:
providing a tortilla shell with an inner and an outer face;
providing a food core;
perforating the tortilla shell;
wrapping the food core in the tortilla shell with the food core adjacent the inner face of the tortilla shell;
cooking the wrap; and
removing the wrap and allowing it to cool

2. The method of claim 1 wherein the cooking step includes deep frying the wrap.

3. The method of claim 1 wherein the cooking step includes the step of heating the wrap on a roller grill.

4. The method of claim 1 further including a step of providing a quill cutter.

5. The method of claim 4 wherein the perforating step includes the step of rolling the quill cutter across the tortilla shell.

6. The method of claim 1 further including, prior to the wrapping step, the step of misting the tortilla shell.

7. The method of claim 1 further including the step of providing a case for the storage and handling of a multiplicity of wrapped food products.

8. The method of claim 7 further including, after the removing step, the step of placing the wrap in the case.

9. The method of claim 1 further including, after the wrapping step and before the cooking step, the step of freezing the wrap.

10. The method of claim 9 further including the step of providing a case for storage and handling of a multiplicity of wrapped food products and wherein, before the freezing step, further including the step of placing the wraps in the case.

11. The method of claim 1 wherein the wrapping step includes the step of tightening the wrap such that a portion of the inner face of the tortilla shell is flush against an outer surface of the sausage and a portion of the inner face of the tortilla shell is flush against a portion of the outer face of the tortilla shell.

12. The method of claim 1 further including, prior to the wrapping step, the step of coating the inside face of the tortilla shell with flavoring.

13. The method of claim 2 wherein the cooking step proceeds in a cooking oil heated to a temperature in the range of about 300° to 500° until the tortilla shell is a golden brown color, whereupon it is removed from the cooking oil.

14. The method of claim 2 wherein the perforations are either cylindrical or slotted.

15. The method of claim 14 wherein the perforations are randomly located.

16. The method of claim 3 wherein the tortilla shell of the providing step includes about ½ to 1% cooking oil.

17. The method of claim 1 wherein the food core is one of the following: bean product, egg product, frankfurter or sausage link.
